(19) United States
(12) Patent Application Publication
(10) Pub. No.: US 2014/0105658 A1
(43) Pub. Date: Apr. 17, 2014

(54) IMAGE HEATING APPARATUS

(71) Applicant: Masayuki Tamaki, Abiko-shi (JP)

(72) Inventor: Masayuki Tamaki, Abiko-shi (JP)

(73) Assignee: CANON KABUSHIKI KAISHA, Tokyo (JP)

(21) Appl. No.: 14/125,443

(22) PCT Filed: Aug. 31, 2012
(86) PCT No.: PCT/JP2012/072829

§ 371 Date: Dec. 11, 2013

(30) Foreign Application Priority Data
Sep. 1, 2011 (JP) 2011-190725

(51) Int. Cl. G03G 15/20

(52) U.S. Cl. CPC G03G 15/2053
USPC 399/329

(57) ABSTRACT

An image heating apparatus includes: an endless belt for heating a toner image on a recording material in a nip; an exciting coil for heating the belt by electromagnetic induction heating; rotatable driving member for forming the nip between itself and the belt and for rotationally driving the belt; a magnetic flux suppressing member for suppressing magnetic flux when a predetermined recording material having a width narrower than a maximum-width recording material usable in the image heating apparatus is subjected to image heating, wherein the magnetic flux, of magnetic flux directed from the exciting coil toward the belt, is directed toward a part of a region outside, with respect to a widthwise direction of the belt, of a region where the belt is contactable to the predetermined recording material; and a rotatable heat-absorbing member for absorbing heat from the rotatable driving member in contact therewith.

### TECHNICAL FIELD

The present invention relates to an image heating apparatus for heating a toner image on a recording material. This image heating apparatus is usable in an image forming apparatus such as a copying machine, a printer, a facsimile machine or a multi-function machine having a plurality of functions of these machines.

### BACKGROUND ART

In a conventional fixing device (image heating apparatus) for an electrophotographic image forming apparatus, at a nip between a fixing belt (endless belt) and a pressing roller (rotatable driving member), the toner image formed on the recording material (recording paper) is subjected to fixing (image heating) under heat and pressure.

In such a fixing device, employment of an electromagnetic induction heating type in which thermal capacity is decreased in order to quickly increase a temperature of the fixing belt (high-speed temperature rise) and in which a heating efficiency is good has been proposed.

However, when a thin fixing belt is used for decreasing the thermal capacity, a degree of heat transfer in a widthwise direction of the fixing belt is lowered. This tendency is conspicuous with a decrease in thickness of the fixing belt, and the degree of the heat transfer is further lowered when the fixing belt is formed of a material, such as a resin, having a low thermal conductivity. This is also clear from the Fourier's law such that a heat quantity Q transferred per unit time is represented by Q=λ·f(θ1−θ2)/L where λ is the thermal conductivity, (θ1−θ2) is a temperature difference between two points and L is a length.

Thus, in the case where the thermal conductivity of the fixing belt with respect to the widthwise direction is low, when a recording material having a width narrower than a maximum-width recording material usable in the fixing device is subjected to fixing, there is a possibility that a widthwise end portion region of the fixing belt in which the fixing belt is not contactable to the recording material is excessively heated.

Therefore, in a fixing device described in Japanese Laid-Open Patent Application (JP-A) 2001-194940, the excessive temperature rise in the widthwise end portion region of the fixing belt is intended to be suppressed by moving a part of magnetic cores away from the fixing belt. However, even when the part of the magnetic cores is moved away from the fixing belt in such a manner, in the widthwise end portion region of the fixing belt, the fixing belt is not completely prevented from being heated by an exciting coil and therefore the widthwise end portion region temperature is also increased to a non-negligible level during continuous fixing.

Incidentally, there is a possibility that this problem is solved by moving the part of the magnetic cores considerably away from the fixing belt to the extent that the temperature rise in the widthwise end portion region of the fixing belt is negligible, but there is a need to provide a large retraction space for the magnetic cores for that purpose, so that such a countermeasure cannot be practical.

Further, it would be considered that all the magnetic flux directed from the exciting coil toward the widthwise end portion region of the fixing belt is shielded by a magnetic flux shielding plate (magnetic flux suppressing member) to prevent the fixing belt from being subjected to electromagnetic induction heating in the region, but for that purpose, the magnetic flux shielding plate is required to be a rotatable movement type or a slidable type along the widthwise direction of the fixing belt.

However, in the case where the magnetic flux shielding plate is of the rotatable movement type, when a cross-sectional diameter of the fixing belt is small, devices (such as a separating mechanism) disposed at a periphery of the fixing belt constitute an obstacle, so that a space for permitting retraction of the magnetic flux shielding plate by rotationally moving the magnetic flux shielding plate during non-shielding cannot be provided and thus such a countermeasure is not practical. Further, even in the case where the magnetic flux shielding plate is of the slidable type, a space in which the magnetic flux shielding plate having a length capable of meeting a minimum-width recording material is completely retracted to the outside of the widthwise end portion region of the fixing belt during the non-shielding is required to be provided, with the result that the fixing device is increased in size.

### SUMMARY OF THE INVENTION

A principal object of the present invention is to provide an image heating apparatus capable of suppressing excessive temperature rise of an endless belt without causing an increase in size of the image heating apparatus.

According to an aspect of the present invention, there is provided an image heating apparatus comprising: an endless belt for heating a toner image on a recording material in a nip; an exciting coil for heating the endless belt by electromagnetic induction heating; a rotatable driving member for forming the nip between itself and the endless belt and for rotationally driving the endless belt; a magnetic flux suppressing member for suppressing magnetic flux when a predetermined recording material having a width narrower than a maximum-width recording material usable in the image heating apparatus is subjected to image heating, wherein the magnetic flux, of magnetic flux directed from the exciting coil toward the endless belt, is directed toward a part of a region outside, with respect to a widthwise direction of the endless belt, of a region where the endless belt is contactable to the predetermined recording material; and a rotatable heat-absorbing member for absorbing heat from the rotatable driving member in contact therewith.

### BRIEF DESCRIPTION OF THE DRAWINGS

FIG. 1 is a schematic sectional view of a structure of an image forming apparatus according to First Embodiment of the present invention.

FIG. 2 is a schematic cross-sectional view of a sheet passing region of a fixing device in First Embodiment.

FIG. 3 is a structural vie of layers of a fixing belt.

Part (a) of FIG. 4 is a schematic longitudinal sectional view of the fixing device in First Embodiment, and (b) of FIG. 4 is an enlarged schematic cross-sectional view of a driving portion for driving a (heat-)soaking roller.

FIG. 5 is an exploded perspective view of a principal part of the fixing device.

FIG. 6 is a schematic cross-sectional vie of a non-sheet-passing region of the fixing device in First Embodiment.

FIG. 7 is a graph showing a relationship between a temperature and melt viscosity of a toner used in First Embodiment.

FIG. 8 is a graph showing a relationship between a print number of sheets and a surface temperature of the fixing belt when the soaking roller is contacted to a pressing roller from start of a job.

FIG. 9 is a schematic illustration showing a temperature distribution of a surface of the fixing belt in a sheet passing region.

FIG. 10 is a block diagram for illustrating control in First Embodiment.

FIG. 11 is a flow chart for illustrating the control in First Embodiment.

FIG. 12 is a timing chart for illustrating the control in First Embodiment.

FIG. 13 is a graph showing a relationship between the print number of sheets and the fixing belt surface temperature, in First Embodiment and a conventional (comparative) embodiment, for illustrating an effect of First Embodiment.

FIG. 14 is a graph showing a relationship between the print number of sheets and non-sheet-passing portion temperature rise in First Embodiment.

FIG. 15 is a block diagram for illustrating control in Second Embodiment.

FIG. 16 is a flow chart for illustrating the control in Second Embodiment.

FIG. 17 is a graph showing a relationship between the print number of sheets and the fixing belt surface temperature for illustrating an effect of Second Embodiment.

FIG. 18 is a graph for illustrating non-sheet-passing portion temperature rise at sheet passing of 500-th sheet in Second Embodiment.

### BEST MODE FOR CARRYING OUT THE INVENTION

Embodiments of the present invention will be described specifically with reference to the drawings. In the following, the case where the present invention is applied to an electrophotographic color copying machine including a plurality of photosensitive members will be described. However, the present invention is not limited thereto but may also be applicable to electrophotographic copying machines of various types, printers, monochromatic machines and image forming apparatuses of types other than the electrophotographic type.

### First Embodiment

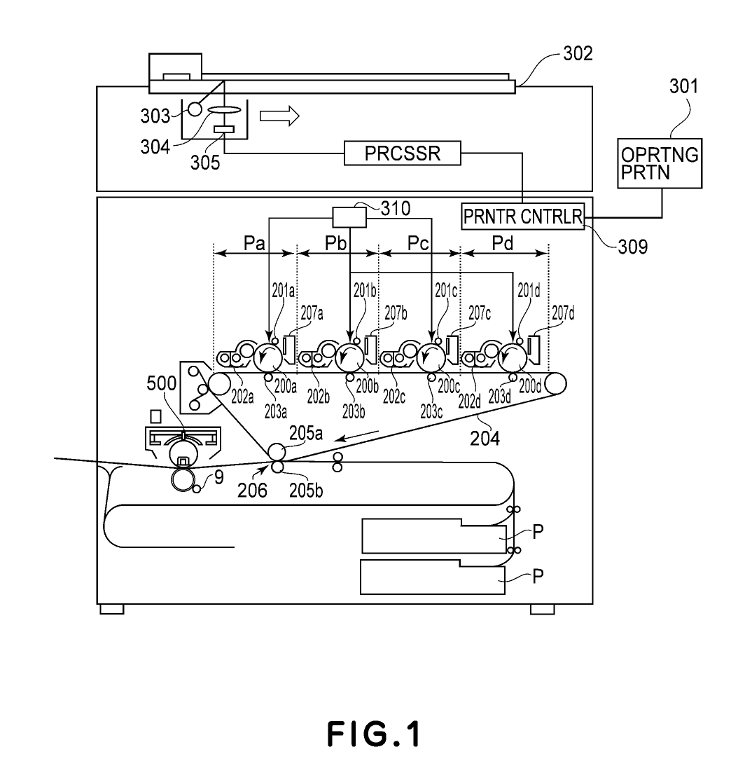

First Embodiment of the present invention will be described with reference to FIGS. 1 to 14. First, with reference to FIG. 1, a general structure of an image forming apparatus in this embodiment will be described.

### [Image Forming Apparatus]

An original placed on an original supporting platen glass 302 is irradiated with light from a light source 303, and the light is focused on a CCD sensor 305 via an optical system 304. This reading optical unit scans the original in an arrow direction to convert the original into electric signal data column every line. An image signal obtained by the CCD sensor 305 is sent to a printer portion and is image-processed correspondingly to a printer by a printer controller 309. The printer controller 309 can also receive external input, as the image signal, from a print server or the like.

Next, the printer portion will be described. The image signal is converted into a laser beam which is subjected to PWM (pulse width modulation) by the printer controller 309. In FIG. 1, photosensitive drums 200a-200d, as an image bearing member, of image forming portions Pa-Pd are irradiated and scanned with the laser beam through a polygonal scanner 310. The image forming portions Pa-Pd from images of colors of yellow (Y), magenta (M), cyan (C) and black (Bk), respectively. The image forming portions Pa-Pd have the substantially same constitution and therefore in the following, details of the image forming portion Pa or Y (yellow) will be described representatively and description of other image forming portions will be omitted.

In the image forming portion Pa, the photosensitive drum 200a is irradiated with the laser beam from the polygonal scanner 310, so that an electrostatic latent image is written on the surface of the photosensitive drum 200a. A primary charger 201a electrically charges the surface of the photosensitive drum 200a to a predetermined potential to prepare for the formation of the electrostatic latent image. A developing device 202a develops the electrostatic latent image, on the photosensitive drum 200a, to form a toner image. A transfer roller 203a effects electric discharge from a back surface of an intermediary transfer belt 204 and is supplied with a primary transfer bias of a polarity opposite to a toner charge polarity, so that the toner image is transferred from the photosensitive drum 200a onto the intermediary transfer belt 204. The surface of the photosensitive drum 200a after the transfer is cleaned by a cleaner 207a.

Further, the toner image on the intermediary transfer belt 204 is conveyed to subsequent image forming portions, where color toner images formed at respective image forming portions in the order of M, C and Bk are successively transferred, so that four color toner images are formed on the surface of the intermediary transfer belt 204. The toner images passing through the image forming portion Pd for Bk are conveyed to a secondary transfer portion 206 constituted by a secondary transfer outer roller 205b and the intermediary transfer belt 204 contacted to a secondary transfer inner roller 205a. Then, at the secondary transfer portion 206, a secondary transfer electric field of the opposite polarity to the toner charge polarity is applied, so that the toner images are secondary-transferred onto a recording material (recording paper) P. Thereafter, unfixed toner images on the recording material P are fixed as an image on the recording material P by a fixing device 500.

### [Fixing Device]

In the following description, with respect to the fixing device as an image heating apparatus and members constituting the fixing device, a longitudinal direction refers to a direction perpendicular to a recording material conveyance direction in a plane of a recording material conveyance path. Further, a widthwise direction refers to a direction parallel to the recording material conveyance direction. With respect to the fixing device, a front surface refers to a surface of the fixing device as seen from a recording material entrance side, and a rear surface refers to an opposite surface (recording material exit side) from the front surface. Left and right refer to those of the fixing device as seen from the front surface. Upstream side and downstream side are those with respect to the recording material conveyance direction. Further, a widthwise direction of a fixing belt is substantially parallel to a direction perpendicular to the recording material conveyance direction.

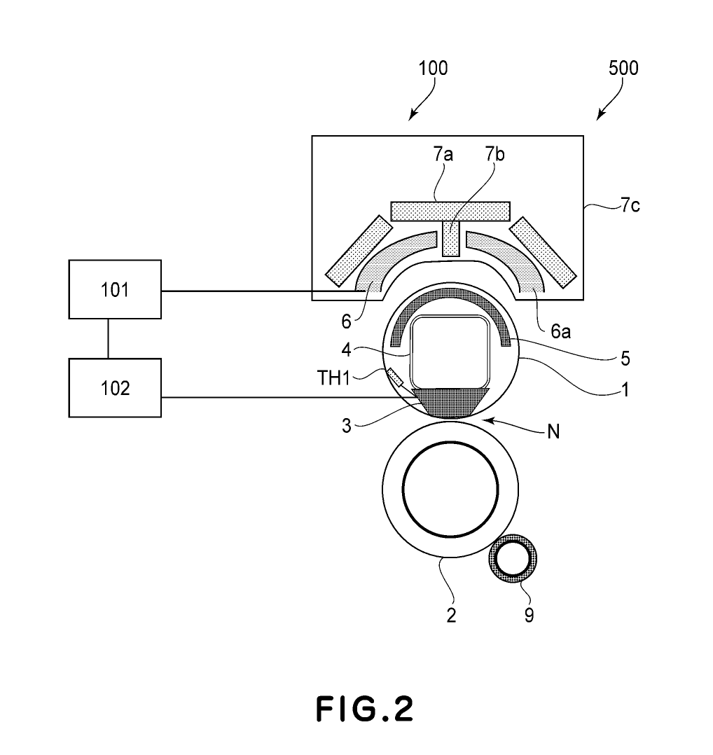

FIG. 2 is a sectional view of a region (sheet passing region) of the fixing device 500 where the recording material passes in this embodiment. The fixing device 500 includes a fixing belt 1 as a rotatable heating member, a pressing roller 2 as a rotatable pressing member (rotatable driving member), an induction heating device 100 and a (heat-)soaking roller 9 as a (heat-)soaking member (rotatable heat-absorbing member). The fixing belt 1 is an endless belt having a metal layer. The pressing roller 2 is contacted to an outer peripheral surface of the fixing belt 1 to form a nip N. A pressure-applying member 3 applies pressure between the fixing belt 1 and the pressing roller 2 to form the nip N and is held by a stay 4 formed of metal.

The induction heating device 100 is a heating source (induction heating means) for induction-heating the fixing belt 1. The induction heating device 100 includes an exciting coil 6 and outside core 7a. The exciting coil 6 is a magnetic flux generating means and uses, e.g., Litz wire as electric wire and is prepared by winding the Litz wire in an elongated ship's bottom-like shape so that the wound wire opposes the peripheral surface of the fixing belt 1 and a part of a side surface of the fixing belt 1. The outside core 7a is a magnetic core for covering an outside of the exciting coil 6 so that magnetic flux generated by the exciting coil 6 can be prevented from being substantially leaked into a portion other than the metal layer (electroconductive layer) of the fixing belt 1. The magnetic core is provided in a plurality of magnetic cores which are arranged in a widthwise direction of the fixing belt 1. These exciting coil 6 and outside core 8a are supported by an electrically insulative mold member 7c of a resin material.

The thus-constituted induction heating device 100 is, in an opposite side to the pressing roller 2, disposed opposed to the outer peripheral surface of the fixing belt 1 with a predetermined gap (spacing) form the fixing belt 1. Further, in the fixing belt 1, in a side where the stay 4 opposes the exciting coil 6, an inside core 5 for constituting a magnetic closed circuit between itself and the outside core 7a is provided.

In a rotation state of the fixing belt 1, a high-frequency current of 20-50 kHz is applied from a power source device (exciting circuit) 101 to the exciting coil 6 of the induction heating device 100, so that the metal layer (electroconductive layer) of the fixing belt 1 is induction-heated by the magnetic field generated by the exciting coil 6. That is, the fixing belt 1 in this embodiment generates heat by passage of the magnetic flux generated by the induction heating device 100. Incidentally, in this embodiment, the power source device 101 is provided in the printer controller 309.

A temperature sensor (temperature detecting element) TH1 such as a thermistor is provided at a position of a central inner surface portion of the fixing belt 1 with respect to the widthwise direction in contact to the fixing belt 1. The temperature sensor TH1 detects a temperature of a fixing belt constituting a sheet passing region and information on the detected temperature is fed back to a control circuit portion 102 in the printer controller 309. Incidentally, the temperature sensor TH1 detects the temperature of the fixing belt 1 at an inner peripheral surface of the fixing belt 1 but its detection information is converted into a surface temperature of the fixing belt 1 by using a table or the like stored in, e.g., a memory in the control circuit portion 102. Therefore, the surface temperature of the fixing belt 1 can be detected by the temperature sensor TH1.

The control circuit portion (controller) 102 controls electric power to be inputted from the temperature sensor TH1 into the exciting coil 6 so that the detected temperature inputted from the temperature sensor TH1 can be kept at a target temperature (fixing temperature). That is, in the case where the detected temperature of the fixing belt 1 is increased to a predetermined temperature, energization to the exciting coil 6 is interrupted. In this embodiment, the electric power to be inputted into the exciting coil 6 is controlled, on the basis of a detected value of the temperature sensor TH1, by changing the frequency of the high-frequency current so that the surface temperature of the fixing belt 1 can be kept at 180° C. as the target temperature.

The temperature sensor TH1 is mounted on the pressure-applying member 3 via an elastic supporting member and even when positional fluctuation such as waving of a contact surface of the fixing belt 1 is generated, the temperature sensor TH1 is constituted so that it can follow the positional fluctuation and thus can be kept in a good contact state.

At least during execution of image formation, the pressing roller 2 is rotationally driven by a motor (driving means) controlled by the control circuit portion 102, so that the fixing belt 1 is constituted so as to be rotated by the rotation of the pressing roller 2. In this case, the fixing belt 1 is rotationally driven at a peripheral speed substantially equal to a conveying speed of the recording material P, carrying thereon then the unfixed toner images, conveyed from the secondary transfer portion 206. In this embodiment, the fixing belt is rotated at a surface rotational speed of 300 mm/sec and is capable of fixing a full-color image on 80 sheets per minute for A4-sized recording material and 58 sheets per minute for A4R-sized recording material.

Further, in a state in which the electric power is supplied from the power source device 101 to the exciting coil 6 and the fixing belt 1 is increased in temperature to a predetermined fixing temperature and then is temperature-controlled at the fixing temperature, the recording material P carrying thereon the unfixed toner images is introduced into the nip N with its toner image carrying surface toward the fixing belt 1. Then, in the nip N, the recording material P is intimately contacted to the outer peripheral surface of the fixing belt 1 and is nip-conveyed together with the fixing belt 1 through the nip N. As a result, heat of the fixing belt 1 is principally applied to the recording material P and the pressure of the nip N is applied to the recording material P, so that the unfixed toner images are fixed on the surface of the recording material P by heat and pressure.

The recording material P passing through the nip N is self-separated from the outer peripheral surface of the fixing belt 1 by deformation of the surface of the fixing belt 1 at an exit portion of the nip N and then is conveyed to an outside of the fixing device.

The soaking roller 9 is contacted to the pressing roller 2 to dissipate heat of the pressing roller 2. For this reason, the soaking roller 9 is a high heat conductive roller and has a metal layer or a layer of carbon material, and is constituted by a cylindrical member at its outer peripheral surface. The soaking roller 9 is provided so as to be movable toward and away from the pressing roller 2 by a contact-and-separation means described later. Such a soaking roller 9 has a length in axial direction equal to or somewhat shorter than that of the pressing roller 2 and is contacted to the pressing roller 2, so that the soaking roller 9 is rotated by the rotation of the pressing roller 2. In this case, heat due to the temperature rise of the fixing belt 1 in a region other than the sheet passing region is absorbed by the pressing roller 2, and the absorbed heat by the pressing roller 2 is dissipated by the soaking roller 9, so that overheating of the fixing belt 1 is suppressed.

The soaking roller 9 may preferably be a cylindrical member of a material which is, e.g., 100 W/m·K or more in thermal conductivity at 100-250° C. and is, e.g., 3.0 kJ/m³·K or more at 100-250° C. For example, the soaking roller 9 is constituted so as to have a metal layer of aluminum, copper or the like or a layer of carbon material such as carbon fiber or carbon nanotube. These materials have a high thermal conductivity. As a specific example, the soaking roller 9 is constituted by providing a rotation shaft at the center of both end portions of the above-described cylindrical member of the metal or the carbon material. Dimensions of respective portions are, e.g., such that a diameter (axial diameter) of the rotation shaft is 8 mm, an outer diameter of the cylindrical portion is 20 mm and a longitudinal length of the cylindrical portion is 300 mm. Further, the cylindrical portion has a solid structure in which an inside thereof a filled with the above-described material. Incidentally, the soaking roller 9 may also be constituted so that a parting layer (of, e.g., PFA resin) is provided on a base layer (metal layer).

### [Fixing Belt]

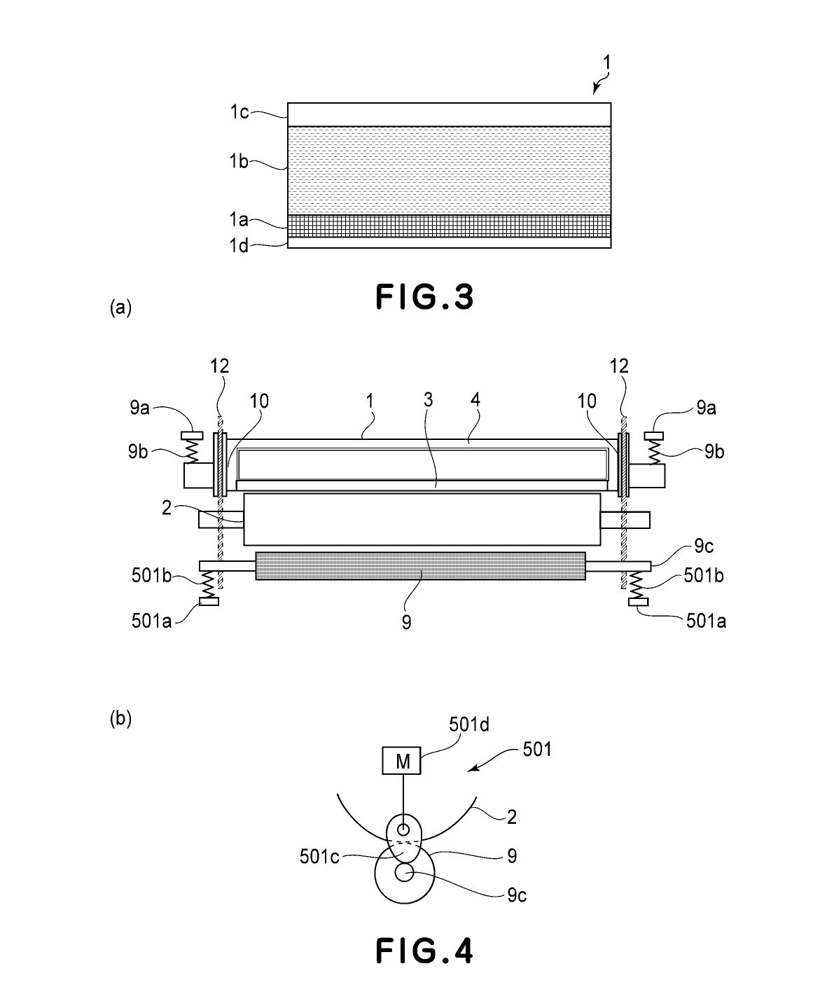

Next, with reference to FIG. 3, the fixing belt 1 in this embodiment will be described more specifically. FIG. 3 is a partially cutaway view showing a layer structure of the fixing belt 1. The fixing belt 1 has a base layer (metal layer) 1a manufactured of, e.g., nickel in an inner diameter of 30 mm by electro-casting. A thickness of the base layer 1a is 40 μm.

On the outer peripheral surface of the base layer 1a, a heat-resistant silicone rubber layer is provided as an elastic layer 1b. The thickness of the silicone rubber layer may preferably be set in a range of 100-1000 μm. In this embodiment, in view of shortening of warm-up time by decreasing a heat quantity of the fixing belt 1 and obtaining of a fixing image suitable when a color image is fixed, the thickness of the silicone rubber layer is set at 300 μm. The silicone rubber layer has a hardness of 20 degrees as JIS-A hardness and the thermal conductivity of 0.8 W/mK. On the outer peripheral surface of the elastic layer 1b, a fluorine-containing resin layer (of, e.g., PFA or PTFE) as a surface parting layer 1c is provided in a thickness of 30 μm.

On an inner surface of the base layer 1a, in order to lower sliding friction between the fixing belt inner surface and the temperature sensor TH1, a resin layer (lubricating layer) 1d of fluorine-containing resin or polyimide may be provided in a thickness of 10-50 μm. In this embodiment, the layer of polyimide was formed in the thickness of 20 μm.

As the material for the base layer 1a, iron alloy, copper, silver and the like other than nickel are appropriately selectable. Further, it is also employ a constitution in which a layer of the above-described metal layer is laminated on a resin base layer. The thickness of the base layer 1a may be adjusted depending on factors described layer including the frequency of a high-frequency current carried in the exciting coil and a permeability/electroconductivity of the metal layer, thus being preferable that the thickness of the base layer 1a is set in a range of about 5-200 μm.

### [Pressing Roller]

The pressing roller 2 (rotatable driving member) for forming the nip N between itself and the fixing belt 1 is prepared by providing a silicone rubber layer as an elastic layer of, e.g., 30 mm in outer diameter, on an iron alloy-made core metal of, e.g., 20 mm in diameter of a longitudinal central portion and 19 mm in diameter of longitudinal end portions. On the surface of the elastic layer, as a parting layer, a fluorine-containing resin layer (of, e.g., PFA or PTFE) is provided in a thickness of about 30 μm. The hardness of the pressing roller 2 at the longitudinal central portion is 70 degrees as ASKER-C hardness.

A width of the nip N between the fixing belt 1 and pressing roller 2 with respect to a rotational direction in this embodiment is about 9 mm at longitudinal end portions and is about 8.5 mm at a longitudinal central portion at a fixing nip pressure of 600 N. This is advantageous in that paper creases are not readily generated since a conveying speed of the recording material P at the longitudinal end portion is higher than that at the longitudinal central portion.

With reference to (a) and (b) of FIG. 4, a constitution for applying the pressure for forming the nip N and a contact-and-separation mechanism 501 as the contact-and-separation means for moving the soaking roller 9 toward and away from the pressing roller 2 will be described. First, the constitution for forming the nip N will be described.

As shown in (a) of FIG. 4, left and right flange members 10 as a regulating (preventing) member for regulating (preventing) longitudinal movement of and a circumferential shape of the fixing belt 1 are provided. Between each of end portions of a stay 4 provided by being inserted into the associated fixing flange 10 and each of a spring receiving members 9a for the stay provided in a device chassis side, a stay pressing spring 9b is compressedly provided, so that a force for urging the stay 4 toward the pressing roller 2 is caused to act on the stay 4. A pressure-applying member 3 as described above is held by the stay 4 of metal. The pressure-applying member 3 is formed of a heat-resistant resin, and the stay 4 is required to have rigidity for applying the pressure to the press-contact portion and therefore is formed of iron in this embodiment.

As described above, the force for urging the stay 4 toward the pressing roller 2 is caused to act on the stay 4 by the stay pressing spring 9b, so that the pressure-applying member 3 held by the stay 4 and the pressing roller 2 are pressed toward each other via the fixing belt 1 disposed therebetween. Thus, the nip N with a predetermined width is formed between the fixing belt 1 and the pressing roller 2.

Incidentally, the base layer of the rotating fixing belt 1 is constituted by metal and therefore as a means for regulating (preventing) lateral deviation (shift) in the widthwise direction even in the rotation state, provision of the fixing flange 10 for only simply receiving the end portion of the fixing belt 1 is sufficient. As a result, there is an advantage that the constitution of the fixing device can be simplified. Supporting side plates 12 for supporting the fixing belt 1 is provided. By the supporting side plates 12, a longitudinal position of the fixing belt 1 is regulated.

The pressing (urging) between the soaking roller 9 and the pressing roller 2 is effected by a pressing (urging) spring 501b of the contact-and-separation mechanism 501. The pressing spring 501b is provided in an elastically compressed state between the spring receiving member 501a in the device side and a rotation shaft 9c of the soaking roller 9, so that a force for urging the soaking roller 9 toward the pressing roller 2 is caused to act on the soaking roller 9. As a result, the soaking roller 9 and the pressing roller 2 are press-contacted to form a nip, with a predetermined width, between the soaking roller 9 and the pressing roller 2. As a result, the soaking roller 9 is constituted so as to be rotated by the rotation of the pressing roller 2.

On the other hand, as shown in (b) of FIG. 4, the contact-and-separation mechanism 501 includes a cam 501c provided so as to contact the rotation shaft 9c of the soaking roller 9 and a motor 501d for rotationally driving the cam 501c. Further, the cam 501c is rotated by the motor 501d, so that the rotation shaft 9c is moved in a direction in which it is moved away from the pressing roller 2 against an elastic force of the above-described pressing spring 501b. As a result, the soaking roller 9 is spaced from the pressing roller 2. On the other hand, by rotating the cam 501c to change a phase from that in the spaced state thereby to permit the soaking roller 9 to approach the pressing roller 2, so that the soaking roller 9 is contacted to the pressing roller 2 by the elastic force of the pressing spring 501b.

### [Induction Heating Device]

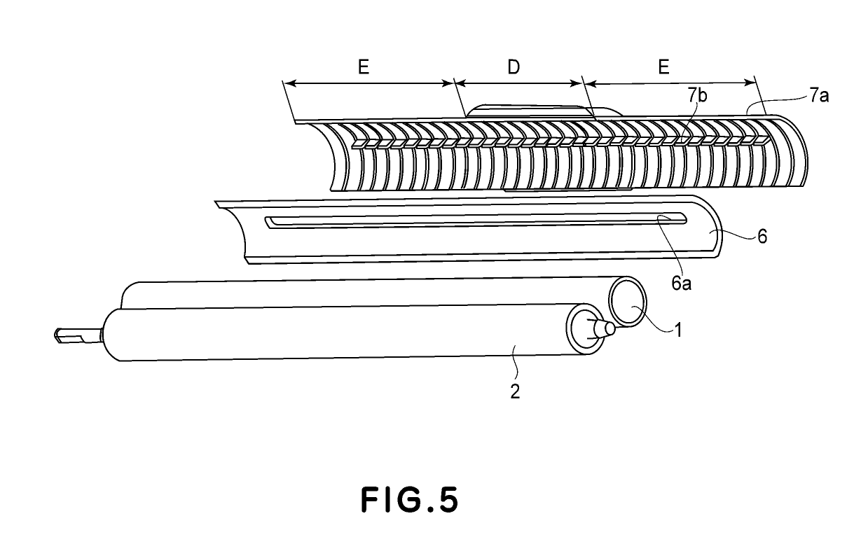

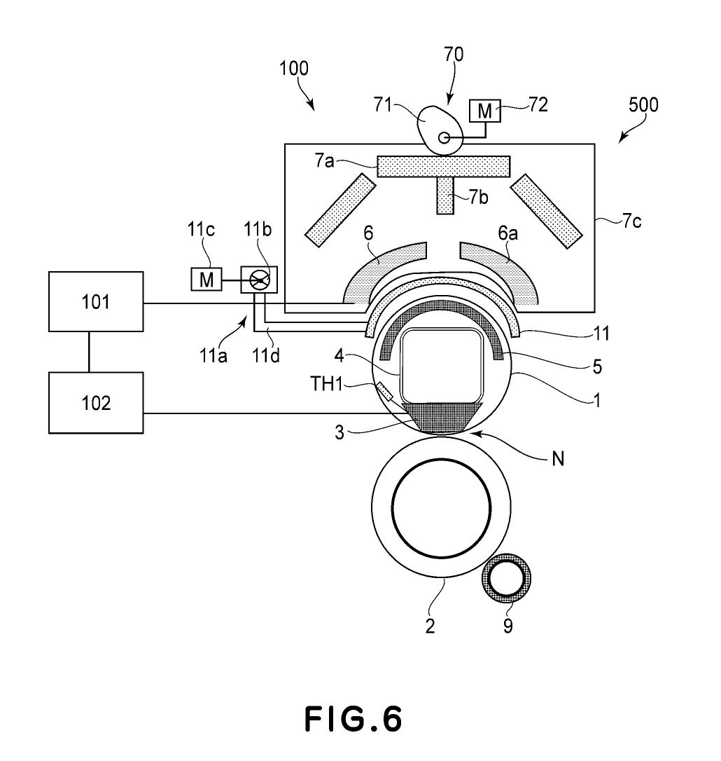

Next, the induction heating device 100 in this embodiment will be described more specifically with reference to FIGS. 5 and 6. For example, the fixing belt 1 and the exciting coil 6 of the induction heating device 100 are kept in an electrically insulated state by the mold member 7c of 0.5 mm in thickness. Further, a gap between the fixing belt 1 and the exciting coil 6 is 1.5 mm (a distance between the surface of the mold member 7c and the fixing belt surface is 1.0 mm) and is constant over the longitudinal direction, so that the fixing belt 1 is heated uniformly over the longitudinal direction.

As described above, to the exciting coil 6, the high frequency current of 20-50 kHz is applied, so that the base layer (metal layer) 1a of the fixing belt 1 is induction-heated. Further, in order to keep the temperature of the fixing belt 1 at 180° C. at the target temperature, the frequency of the high-frequency current is changed on the basis of the detected value of the temperature sensor TH1 to control the electric power to be inputted into the exciting coil 6, so that the fixing belt 1 is temperature-controlled.

The induction heating device 100 including the exciting coil 6 is not disposed inside the fixing belt 1 where the temperature becomes high but is disposed outside the fixing belt 1, so that the temperature of the exciting coil 6 is not readily increased to the high temperature and also an electric resistance is not increased. Therefore, even when the high frequency current is carried, it becomes possible to alleviate loss due to Joule heat generation. Further, by externally disposing the exciting coil 6, it can be said that the provision of the exciting coil 6 also contributes to downsizing (reduction in thermal capacity) of the fixing belt 1 and is also excellent in energy saving property.

With respect to the warm-up time of the fixing device 500 in this embodiment, the thermal capacity is very low and therefore when e.g., 1200 W is inputted into the exciting coil 6, the temperature of the fixing belt 1 reaches 180° C. in about 15 sec. For this reason, a heating operation during stand-by becomes unnecessary, so that an amount of electric power consumption can be suppressed to a low level.

Further, in this embodiment, in order to change a heat generation distribution of the fixing belt 1, the plurality of outside cores 7a are moved. For this reason, in this embodiment, as shown in FIG. 5, the outside cores 7a are arranged in a rotational axis direction (longitudinal direction) of the fixing belt 1 at a position where the outside cores 7a oppose the fixing belt 1. Each of the outside cores 7a is formed in a substantially arcuate shape, provided with a projection 7b at its central portion, so as to cover a winding center portion of the exciting coil 6 and a peripheral portion of the exciting coil 6. Further, the projection 7b is disposed so as to penetrate through a through hole 6a provided at the winding center portion of the exciting coil 6. Incidentally, the outside cores 7a opposing longitudinal end portions of the exciting coil 6 where the through hole 6a is not provided, are not provided with the projection 7b.

The thus-constituted outside cores 7a have the function of efficiently guiding AC magnetic flux generated from the exciting coil 6, to the fixing belt 1. That is, the outside cores 7a are used for increasing an efficiency of a magnetic circuit and for magnetic shielding. As a material for the outside cores 7a, the material such as ferrite which has high permeability and low residual magnetic flux density may preferably be used.

In a state in which the outside cores 7a approach the fixing belt 1 and the projections 7b penetrate through the through hole 6a as shown in FIG. 2 described above, a magnetic closed-circuit is constituted by the outside cores 7a and the inside core 5. Further, the magnetic flux generated by the exciting coil 6 is guided to the fixing belt 1 by the outside cores 7a, so that the fixing belt 1 is caused to generate heat. On the other hand, as shown in FIG. 6, when the outside cores 7a are moved away from the fixing belt 1, the magnetic flux generated by the exciting coil 6 do not readily pass through the fixing belt 1 via the outside cores 7a, so that an amount of heat generation of the fixing belt 1 is liable to lower. As will be described later, even when the outside cores 7a are retracted in a direction in which the outside cores 7a are moved away from the fixing belt 1, the contacts 7a and its opposing region of the fixing belt 1 are placed in a relationship such that they are capable of being subjected to electromagnetic induction heating.

Thus, in order to move the outside cores 7a toward and away from the fixing belt 1, as shown in FIG. 6, the cam mechanism 70 as a magnetic core moving means (retracting mechanism) is disposed in a side opposite from the fixing belt 1 via the outside cores 7a. The cam mechanism 70 is constituted by a plurality of cams 71 and a motor 71 for rotationally driving these cams 71. Each of the cams 71 is disposed correspondingly to, e.g., three outside cores 7a in a region E at each of two longitudinal end portions shown in FIG. 5. A phase of each cam 71 is independently changed, so that at least a part of the outside cores 7a can be selectively spaced from the fixing belt 1. That is, the part of the outside cores 7a is moved toward and away from the fixing belt 1.

Further, in the direction in which the outside cores 7a are spaced from the fixing belt 1, an elastic force is applied by a spring or the like to the outside cores 7a in the region E. Then, by the rotation of the cams 71, the part of the outside cores 7a are brought near to the fixing belt 1 against the elastic force. Then, a heat generation distribution of the fixing belt 1 with respect to the rotational axis direction is controlled. Incidentally, a longitudinal central region D has a sheet passing region width corresponding to a small-sized sheet width, and the sum of widths of the region D and the two regions E is a sheet passing region width corresponding to a large-sized sheet width. For this reason, the outside cores 7a corresponding to the region D are immovably fixed to a housing. Further, the number of the outside cores 7a to be moved by a single cam 71 may be one or two or more but may preferably be set so as to meet sheet passing widths of a plurality of sizes of the recording materials.

In order to meet avoidance of non-sheet-passing portion temperature rise with respect to various paper sizes such as those of post card, A5, B4, A4, A3+, in each of the areas E at the sheet passing end portions, the outside cores 7a are moved toward and away from the fixing belt 1.

For example, a width of each outside core 7a with respect to the longitudinal direction is 10 mm. Further, correspondingly to the recording material size, the outside core 7a is moved, so that the temperature rise at the non-sheet passing portion is suppressed.

Further, in this embodiment, in order to control the heat generation distribution of the fixing belt 1 with respect to the rotational axis direction, a magnetic flux shielding plate 11 as a magnetic flux suppressing member for substantially preventing the magnetic flux generated by the exciting coil 6 from passing through the fixing belt 1 is provided. Such a magnetic flux shielding plate 11 is slidably movable in a direction substantially along the widthwise direction of the fixing belt 1 by a screw mechanism 11a as a moving means (moving mechanism). In this embodiment, the screw mechanism 11a moves the magnetic flux shielding plate in at least a part of a region between the fixing belt 1 and the outside cores 7a or between the outside cores 7 and the exciting coil 6 with respect to the rotational axis direction. Thus, the heat generation distribution of the fixing belt 1 with respect to the rotational axis direction is controlled.

In this embodiment, in the case where the image is formed on the recording material P having a width narrower than a maximum-width recording material, although the outside cores 7a are retracted so as not to cause overheating of the fixing belt 1 in the non-sheet-passing region, in a region W of the non-sheet-passing region, the fixing belt 1 is capable of being increased in temperature. That is, the magnetic flux toward the fixing belt 1 in the region W is not shielded by the magnetic flux shielding plate 11. Therefore, in order to suppress the overheating of the fixing belt 1 in the region W, the soaking roller 9 is contacted to the pressing roller 2, so that the fixing belt 1 is indirectly cooled. As a result, it becomes possible to prevent thermal deterioration of the fixing belt 1 while avoiding an increase in size of the fixing device due to an increase in length of the magnetic flux shielding plate 11 with respect to the widthwise direction (perpendicular to the recording material conveyance direction) of the magnetic flux shielding plate 11.

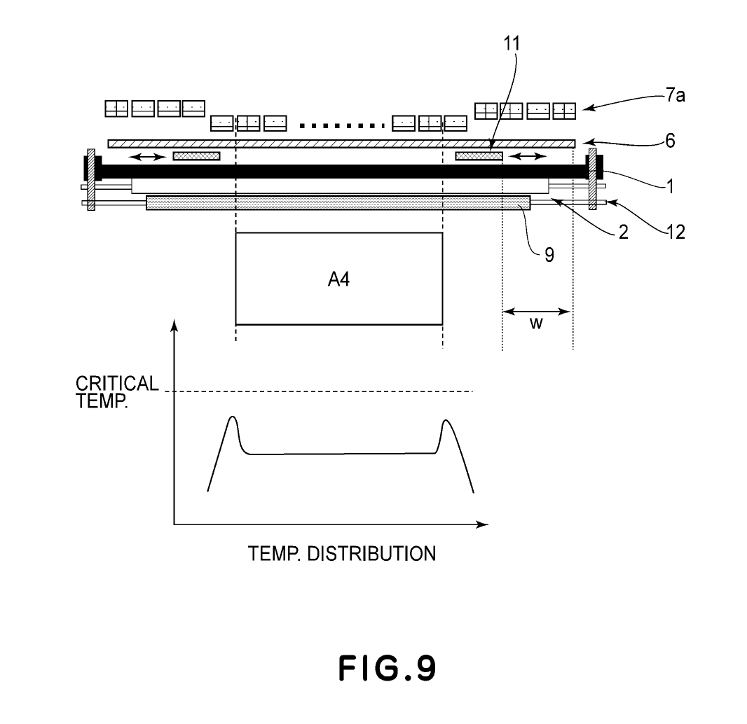

More specifically, as shown in FIG. 9, in the case where an A4-sized recording material is subjected to fixing (first heating), the moving mechanism is controlled by the control circuit portion (controller), so that the magnetic flux shielding plate is moved correspondingly to the widthwise length of the recording material. In the case where a maximum-width recording material is subjected to fixing, the magnetic flux shielding plate is placed in a state in which the magnetic flux shielding plate is completely retracted from the widthwise end portion of the fixing belt, but in this embodiment, in order to avoid an increase in retraction space, the widthwise length of the magnetic flux shielding plate is shortened. Therefore, the magnetic flux toward the region W in FIG. 9 cannot be shielded, so that there arises a problem that the fixing belt temperature is excessively increased in the region W. Specifically, in the region W, the outside cores are retracted from the fixing belt (exciting coil) but in order to avoid the increase in size of the fixing device, a large amount of retraction of the outside cores cannot be ensured, so that the fixing belt is heated to considerable extent.

Therefore, in this embodiment, as described later, the pressing roller is cooled by using the soaking roller, so that the region W of the fixing belt is indirectly cooled. Incidentally, of the region W of the fixing belt, a widthwise end portion is not readily increased excessively in temperature by natural heat dissipation and therefore in this embodiment, an entire area of the region W is partly cooled.

More specifically, as described above, in the non-sheet-passing portion, the gap between the exciting coil 6 and the outside cores 7a is increased to lower the density of the magnetic flux passing through the fixing belt 1, so that the heat generation amount of the fixing belt 1 is lowered. In this embodiment, in this state, as shown in FIG. 6, the magnetic flux shielding plate 11 is inserted between the fixing belt 1 and the exciting coil 6 (and the outside cores 7a) at the non-sheet-passing portion, so that the magnetic flux is substantially prevented from moving toward the fixing belt 1. Thus, the non-sheet-passing portion temperature rise is suppressed.

A material for the magnetic flux shielding plate 11 may be non-magnetic metal such as aluminum, copper, silver, gold or brass or its alloy or may also be a high-permeability material such as ferrite or permalloy. Further, the magnetic flux shielding plate 11 is moved between the exciting coil 6 and the outside cores 7a, between the exciting coil 6 and the fixing belt 1 or between the fixing belt 1 and the inside core 5, so that the magnetic flux is prevented from moving toward the fixing belt 1.

In this embodiment, as shown in FIG. 6, a copper plate is used as the magnetic flux shielding plate 11 and is inserted between the exciting coil 6 and the fixing belt 1. The thickness of the copper plate used is 0.5 mm which is not less than a skin depth. By using the copper plate as the magnetic flux shielding plate 11, such an effect that the magnetic flux is weakened by the core movement to lower the heat generation amount of the base layer 1a of the fixing belt 1 can be further enhanced.

The screw mechanism 11a for moving the magnetic flux shielding plate 11 is moved in interrelation with the cam mechanism 70 as the moving mechanism of the outside cores 7a, the longitudinal heat generation distribution can be controlled finely with a width narrower than a division width of the outside cores 7a. The screw mechanism 11a includes, as shown in FIG. 6, a screw 11b provided in parallel to the longitudinal direction of the fixing belt 1, a motor 11c for rotating the screw 11c and a mold member 11d.

The mold member 11d is formed integrally with the magnetic flux shielding plate 11. Therefore, in this embodiment, the magnetic flux shielding plate 11 is moved by controlling the motor 11c, so that the magnetic flux is shielded at a part of the longitudinal portion of the fixing belt 1.

Such a magnetic flux shielding plate 11 is disposed at each of the longitudinal end portions of the fixing belt 1. Further, the magnetic flux shielding plates 11 disposed at the longitudinal end portions, respectively are mutually moved in opposite directions. That is, the magnetic flux shielding plates 11 are moved in a direction in which they approach each other when the sheet passing width of the recording material is small, and are moved in a direction in which they are moved away from each other when the sheet passing width of the recording material is large. Further, a longitudinal width (width with respect to the direction crossing the recording material conveyance direction) of the magnetic flux shielding plate 11 disposed at each end portion may preferably be set as follows. That is, the longitudinal is set in such a manner that a sufficient width in which a magnetic flux shielding effect is achieved is provided, that a maximum heat generation width corresponding to a maximum size of the sheet subjected to the sheet passing is not decreased, and that the magnetic flux shielding plate 11 can be disposed without enlarging the longitudinal width of the fixing device. Specifically, the longitudinal width was set at 20 mm.

### [Relationship Between Temperature and Melt Viscosity of Toner]

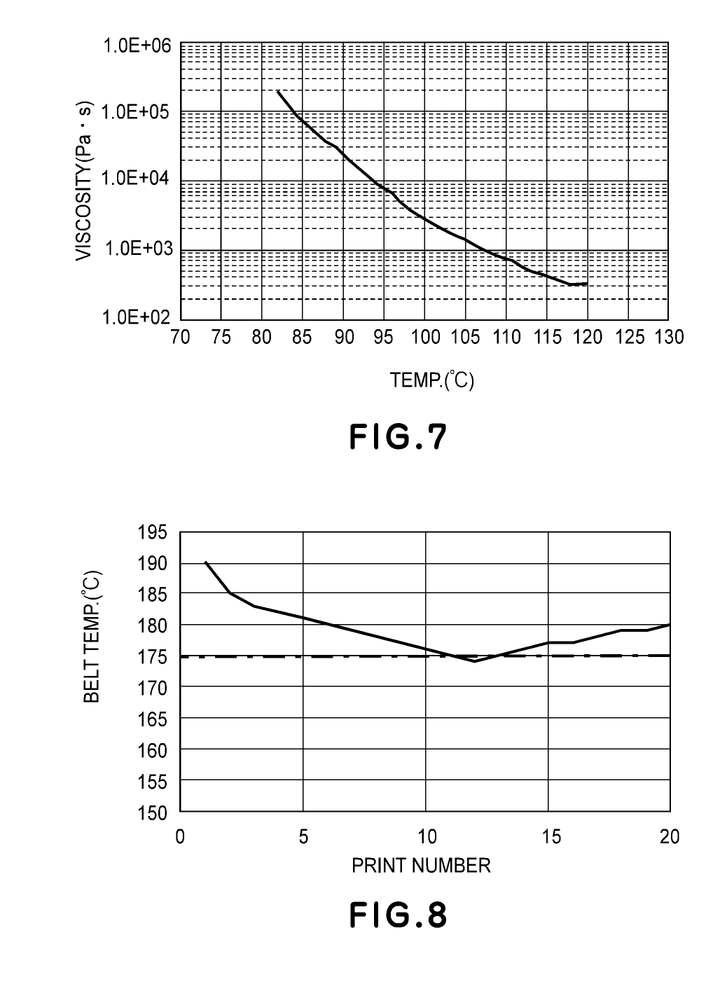

A check result of a relationship between a temperature and a melt viscosity of the toner used in this embodiment is shown in FIG. 7. The melt viscosity of the toner was measured by a flow tester (“CFT-500D” mfd. by Shimadzu Corporation). In accordance with an operation manual of the flow tester, measurement was made under the following condition.

Sample: A toner is weighed in 1.0 g and is molded under pressure of a load of 20 kN for 1 minute by a pressure-molding device with a diameter of 1 cm.

Die hole diameter: 1.0 mm

Die length: 1.0 mm

Cylinder pressure: 9.807×10⁵ (Pa)

Measuring mode: temperature rising method, heating rate: 4.0° C./min

By the above method, the melt viscosity (Pa.$) of the toner was measured in a temperature range of 50-200° C.

### [Relationship Between Print Number of Sheets and Fixing Belt Surface Temperature]

When sheets of an A4-sized recording material (“CF-C104”, available from Canon K.K.) are continuously passed through the fixing device in an environment of a temperature of 15° C. and a relative humidity of 15% RH, a progression of the surface temperature of the fixing belt 1 with respect to a print number of sheets (sheet passing number) is shown in FIG. 8. The belt surface temperature was measured at a belt central portion by using an infrared radiation thermometer “IT2-50”, mfd. by KEYENCE CORPORATION). The measurement was made in a state in which the soaking roller 9 was always contacted to the pressing roller 2 from the time of start of an image forming job.

As shown in FIG. 8, the soaking roller 9 was always contacted to the pressing roller 2 and therefore heat of the pressing roller 2 was taken by the soaking roller 9, so that the belt surface temperature was also lowered. That is, the surface temperature of the fixing belt 1 is started to be lowered simultaneously with the start of the job, i.e., start of sheet passing through the nip as shown in FIG. 8. In this case, the soaking roller 9 is contacted to the pressing roller 2 and therefore the heat of the pressing roller 2 is taken by the soaking roller 9, so that a temperature lowering becomes conspicuous correspondingly. Then, when the print number exceeds a predetermined number (12 sheets in FIG. 8), the temperature lowering is ended and thereafter the temperature is gradually increased. That is, when the print number is the predetermined number, the belt surface temperature is a lowest temperature.

As shown in FIG. 8, when the soaking roller 9 is contacted to the pressing roller 2 from the time of the job start, the lowest temperature is less than 175° C. As shown in FIG. 7 described above, the melt viscosity of the toner is increased with an increasing temperature and therefore a degree of melting of the toner is smaller with a lower belt surface temperature. Particularly, in the case of the toner in this embodiment, when the belt surface temperature is less than 175° C., the degree of melting becomes insufficient, so that the toner is liable to be detached from the recording material. Therefore, in order to prevent the toner from being detached from the recording material, it is preferable that the above-described lowest temperature is 175° C. or more.

### [Temperature Distribution of Fixing Belt Surface in Sheet Passing Region]

The temperature distribution of the fixing belt surface in the sheet passing region will be described. FIG. 9 shows the fixing belt surface temperature distribution when the A4-sized recording material is passed through the nip. The fixing belt surface temperature distribution is shown at a lower side of FIG. 7 corresponding to a schematic illustration of the fixing device, through which the recording material is to be passed, shown in an upper side of FIG. 7.

In this embodiment, the electric power supplied to the exciting coil 6 is set at 1200 W and a size of the recording material to be passed through the fixing device is A4 size and therefore as shown in the upper side of FIG. 9, 4 outside cores 7a at each of the longitudinal end portions are moved apart from the fixing belt 1. Further, the position of the magnetic flux shielding plate 11 is set at 35 mm inside from the closer longitudinal end of the fixing belt 1 (at 15 mm outside from the closer edge of the recording material). The soaking roller 9 is always kept contacted to the pressing roller 2. The longitudinal temperature distribution of the fixing belt 1 shown in the lower side of FIG. 9 was measured by using infrared thermography “FSV-7000S”, mfd. by Apiste Corporation).

As shown in FIG. 9, irrespective of the print number, the belt surface temperature at the non-sheet-passing portion did not exceed a critical temperature at which the influence of the heat is liable to be exerted on the belt. Thus, by appropriately combining movement of the outside cores 7a, and the magnetic flux shielding plate 11 and the soaking roller 9, the overheating at the non-sheet-passing portion of the small-sized paper (recording material) is prevented, so that it is possible to prevent the fixing belt 1 from being broken by the heat. However, as described above with reference to FIG. 8, when the lowest temperature is excessively low, the toner is detached from the recording material.

Therefore, in this embodiment, the soaking roller 9 is spaced from the pressing roller 2 at the time of the start of the image forming job and is contacted to the pressing roller 2 after a predetermined condition is satisfied. That is, timing when the soaking roller 9 is contacted to the pressing roller 2 is delayed. In this embodiment, the predetermined condition is such that a continuous print number exceeds a predetermined number of sheets. That is, the soaking roller 9 is contacted to the pressing roller 2 in the case where a predetermined number of sheets of the recording material are passed through the nip N from start of a continuous image forming job in which image formation of a plurality of sheets of the recording material is continuously effected. The predetermined number of sheets is a number of sheets in which the fixing belt surface temperature reaches the above-described lowest temperature. In other words, in this embodiment, after the belt temperature exceeds the lowest temperature, the soaking roller 9 is contacted to the pressing roller 2.

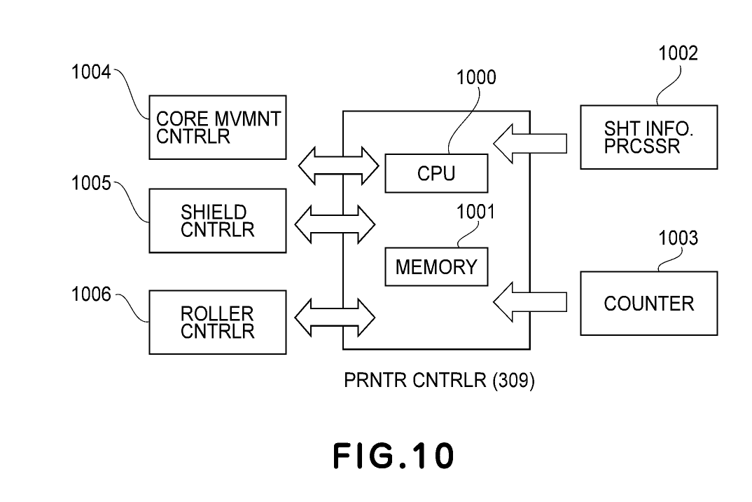

The movement of the soaking roller 9 toward and away from the pressing roller 2 is performed by the above-described contact-and-separation mechanism 501. Further, the contact-and-separation mechanism 501 is controlled by a soaking roller controller 1006 (FIG. 10) as a controlling device.

The above-described constitution in this embodiment will be described more specifically below. Initial positions of the outside cores 7a and the magnetic flux shielding plate 11 in an initial state (state before the controller receives the print job) of the fixing device 500 correspond to those for the A4-sized recording material. Specifically, as described above with reference to FIG. 9, the 4 outside cores 7a are moved upward from each of the longitudinal end portions, and the magnetic flux shielding plate 11 is located at the position of 35 mm inside the longitudinal end of the fixing belt 1. Further, at an initial position, the soaking roller 9 is spaced from the pressing roller 2. At an initial position, the pressing roller 2 is spaced from the fixing belt 1.

The control in this embodiment will be described with reference to a block diagram shown in FIG. 10. Information on the type of the recording material (on the sheet size and the sheet type) inputted from an operating portion 301 by or outputted from a PC (personal computer) by a user is sent to a recording material information processing portion 1002 and then the information of the recording material information processing portion 1002 is transferred to a CPU 1000. The CPU 1000 makes reference to a memory 1001 and discriminates, on the basis of the information of the recording material information processing portion 1002, an amount of movement control of the outside cores 7a and an amount of control of the magnetic flux shielding plate 11 and then transfers the respective control amounts to a core movement controller 1004 and a magnetic flux shielding plate controller 1005. Then, the core movement controller 1004 moves predetermined outside cores 7a away from the fixing belt 1, and the magnetic flux shielding plate controller 1005 moves the magnetic flux shielding plate 11 to a predetermined position.

Further, the number of sheets subjected to image formation is counted by a counter 1003 and its information is transferred to the CPU 1000. This count corresponds to the number of sheets of the recording material passing through the nip N of the fixing device 500. The CPU 1000 makes reference to the memory 1001 on the basis of the information to discriminate timing of the contact of the soaking roller 9. When the CPU 1000 discriminates that the timing is such that the soaking roller 9 should be contacted to the pressing roller 2, the controller sends a command (instruction) to the soaking roller controller 1006, so that the soaking roller controller 1006 brings the soaking roller 9 into contact to the pressing roller 2. That is, when the number of the sheets counted by the counter 1003 reaches a predetermined number (e.g., 12 sheets), the soaking roller controller 1006 brings the soaking roller 9 into contact to the pressing roller 2.

Incidentally, the predetermined number in response thereto the soaking roller 9 is contacted to the pressing roller 2 is appropriately set in consideration of a basis weight of the recording material, a recording material size, an ambient temperature, an amount of the electric power supplied to the fixing device, a surface temperature of the pressing roller at the time of the start of the job, and the like. For example, the predetermined number is set in a range of 3-50 sheets. This set number of sheets may be variably changed in view of the above condition or may be kept constant.

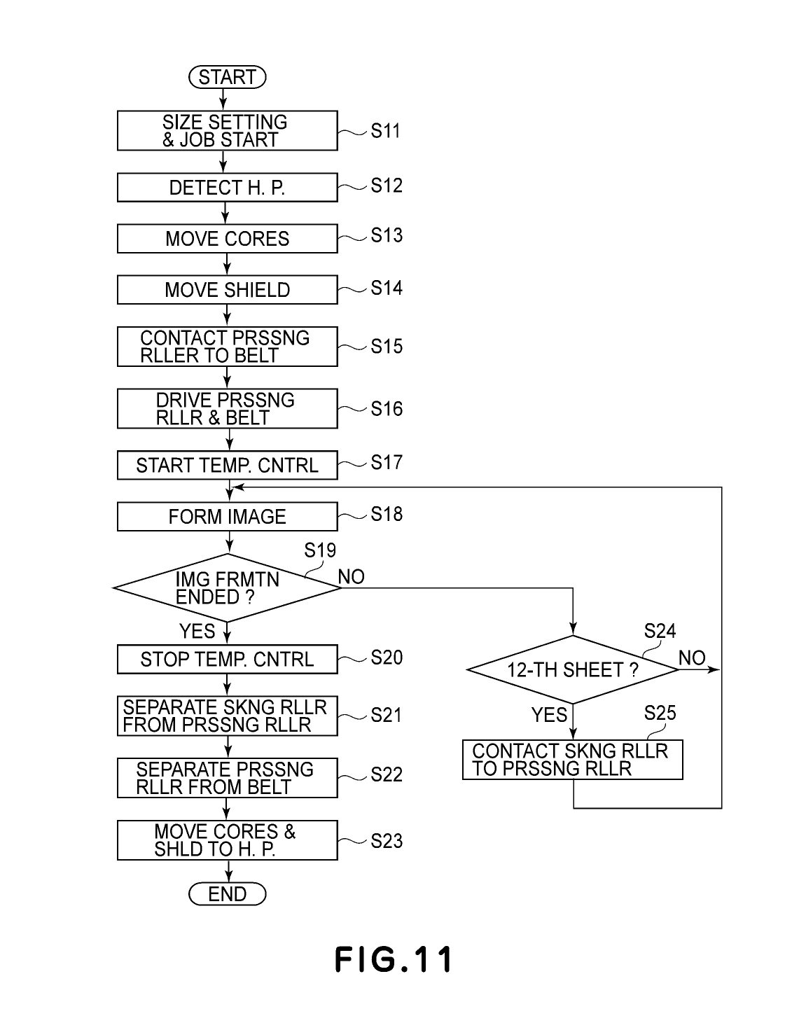

The control flow in this embodiment will be described with reference to FIG. 11. First, the type of the recording material is set through the operating panel or the PC and then a job for copy or print is sent to the image forming apparatus, so that the job is started (S11). Home position detection of the respective members (outside cores 7a, magnetic flux shielding plate 11, soaking roller 9 and pressing roller 2) is performed (S12).

Thereafter, depending on the paper (sheet) size, the outside cores 7a and the magnetic flux shielding plate 11 are moved (S13 and S14). The pressing roller 2 is contacted to and pressed against the fixing belt 1 to form the nip N (S15). The pressing roller 2 is rotationally driven to rotate the fixing belt 1 (S16). A current is carried through the exciting coil 6 to cause the fixing belt 1 to generate heat and then the fixing belt 1 is temperature-controlled (S17). At the image forming portions, the color toner images are formed and then transferred onto the recording material, followed by fixing and output of the image (S18).

Thereafter, when the image forming job is ended (YES of S19), the current passing through the exciting coil 6 is interrupted, so that the temperature control of the fixing belt 1 is stopped (S20). When the soaking roller 9 is contacted to the pressing roller 2, the soaking roller 9 is separated from the pressing roller 2 (S21). Then, the pressing roller 2 is separated from the fixing belt 1 (S22). Then, the outside cores 7a and the magnetic flux shielding plate 11 are moved to their initial positions (home positions) (S23) and thereafter the job is ended.

When the image forming job is not ended (NO of S19), the CPU 1000 discriminates whether or not the print number (of sheets subjected to the image formation) is the predetermined number (12 sheets) (S24). When the print number is less than the predetermined number (12 sheets) (NO of S24), the sequence is returned to S18 and then the image forming operation is continuously repeated. When the print number is not less than the predetermined number (12 sheets) (YES of S24), control such that the soaking roller 9 is contacted to the pressing roller 2 to suppress the non-sheet-passing portion temperature rise is effected (S25). In this case, when the 12-th sheet is counted, the soaking roller 9 is contacted to the pressing roller 2, and this contact state is maintained when the print number is 12 sheets or more. Thereafter, the image forming operation is performed until the job is ended.

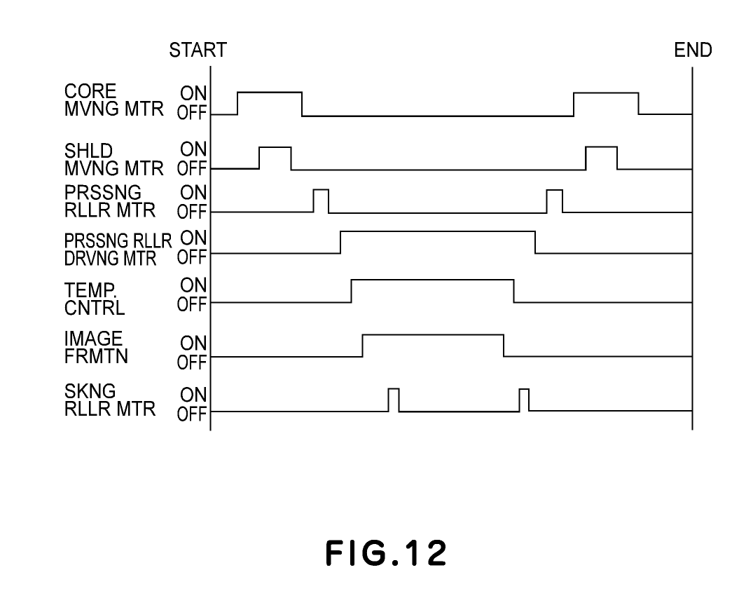

A timing chart of the control in this embodiment will be described with reference to FIG. 12. FIG. 12 is the timing chart when an S5-sized recording material is outputted. In FIG. 12, “START” is a state in which the image forming apparatus receives a print command (signal for starting an image forming job). The sheet passing size is A5 and therefore, first, control such that the motor 72 for moving the outside cores 7a is actuated to move upward 6 outside cores 7a from the end portions is effected. During the movement of the outside cores 7a, the motor 11c for moving the magnetic flux shielding plate 11 is actuated to move the magnetic flux shielding plate 11 to a position of 80 mm in side from the belt end.

Thereafter, a motor for moving the pressing roller 2 toward and away from the fixing belt 1 is driven, so that the pressing roller 2 is contacted to the fixing belt 1 to form the nip N. Then, the pressing roller 2 is driven by the driving motor, so that the pressing roller 2 and the fixing belt 1 are rotationally driven. A voltage is applied to the exciting coil 6, so that the fixing belt 1 is temperature-controlled. Image formation is started, so that an image is outputted on the recording material.

When the print number reaches the predetermined number, the motor 501d for moving the soaking roller 9 toward and away from the pressing roller 2 is driven, so that the soaking roller 9 is contacted to the pressing roller 2 to suppress overheating of the fixing belt 1 at the non-sheet-passing portion. The timing when the soaking roller 9 is contacted to the pressing roller 2 is after the counted sheet number is the predetermined number. For example, the soaking roller 9 is contacted to the pressing roller 2 with timing between count of 12-th sheet and count of 13-th sheet.

When the image formation is ended, the temperature control is stopped and the motor 501d is driven, so that the soaking roller 9 is moved away from the pressing roller 2. Thereafter, the pressing roller driving motor is stopped, so that the drive of the pressing roller 2 is stopped. Then, a pressing roller contact-and-separation motor is driven, so that the pressing roller 2 is separated from the fixing belt 1. Thereafter, the motor 72 for moving the outside cores 7a and the motor 11c for moving the magnetic flux shielding plate 11 are driven, so that the contacts 7a and the magnetic flux shielding plate 11 are moved to their home positions and then the job is ended.

According to this embodiment, the soaking roller 9 is contacted to the pressing roller 2 and therefore the overheating in the region corresponding to the recording material end portion can be suppressed. Further, the soaking roller 9 is separated from the pressing roller 2 during the start of the job and after the predetermined condition is satisfied, i.e., after the predetermined sheet number is counted, the soaking roller 9 is contacted to the pressing roller 2. As described above, the fixing belt 1 causes the largest temperature lowering at the time of the job start. For this reason, as described above, the contact timing of the soaking roller 9 is delayed, so that the temperature lowering of the fixing belt 1 by the contact of the soaking roller 9 can be suppressed and excessive lowering in temperature of the fixing belt 1 can be prevented. Further, it is possible to suppress the detachment of the toner from the recording material.

In this embodiment, the predetermined sheet number in which the soaking roller 9 is contacted to the pressing roller 2 is the sheet number in which the fixing belt temperature reaches the lowest temperature but may also be set under another condition. For example, the condition may be such that the print number is a certain number after the fixing belt temperature exceeds the lowest temperature. Further, in the case where even when the soaking roller 9 is contacted in a certain print number before the fixing belt temperature reaches the lowest temperature, the lowest temperature is not a temperature where the toner is detached from the recording material, the certain print number can be set as the predetermined number. In summary, the soaking roller 9 may only be required to be contacted to the pressing roller 2 with timing such that the lowest temperature does not reach the temperature where the toner is detached from the recording material.

### [Verification Result]

A result of verification of the constitution in this embodiment will be described.

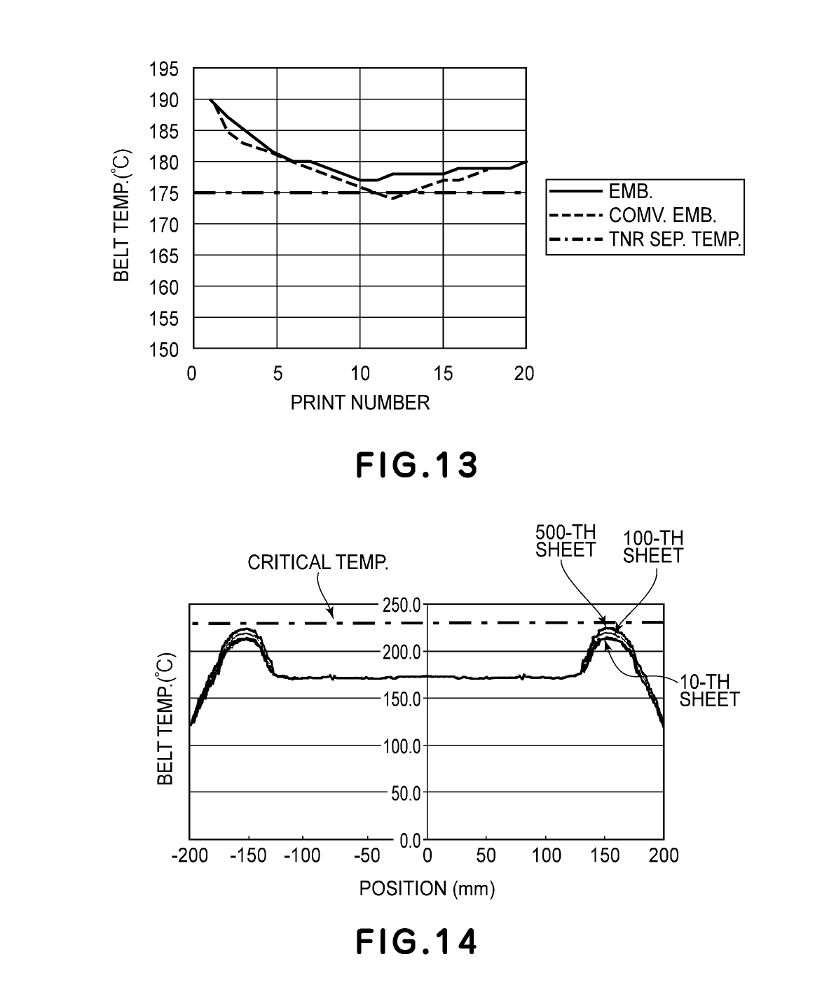

In the fixing device 500 having the above-described constitution, sheets of an A4-sized recording material (“CF-C104”, available from Canon K.K.) were continuously passed through the nip in an environment of a temperature of 15° C. and a relative humidity of 15% RH. First, a progression of the belt surface temperature with respect to a print number of sheets (sheet passing number) is shown in FIG. 13. The belt surface temperature was measured at a belt central portion by using an infrared radiation thermometer “IT2-50”, mfd. by KEYENCE CORPORATION). As shown in FIG. 13, the belt surface temperature is not lowered to 175° C. which is the temperature where the toner is detached (separated) from the recording material.

Next, a longitudinal temperature distribution with respect to the print number when 500 sheets of the recording material are passed through the nip in the fixing device 500 at a rate of 80 ppm (pages (sheets) per minutes) is shown in FIG. 14. The longitudinal temperature distribution of the fixing belt 1 was measured by using infrared thermography “FSV-7000S”, mfd. by Apiste Corporation).

As shown in FIG. 14, even after the 500 sheets subjected to the continuous sheet passing, the temperature at the non-sheet-passing portion was less than 230° C. as a critical temperature, so that the non-sheet-passing portion temperature rise could be suppressed. Incidentally, when the fixing belt temperature is higher than the critical temperature, the belt is deteriorated so that a durable sheet passing number is remarkably decreased.

As described above, when the fixing device in this embodiment is used, even when various types of widthwise sizes of the recording materials are used, it is possible to sufficiently avoid the non-sheet-passing portion temperature rise while preventing an increase in size of the fixing device.

### Second Embodiment

Second Embodiment of the present invention will be described with reference to FIGS. 14 to 18. In the above-described First Embodiment, the case where the timing when the soaking roller is contacted to the pressing roller in such that the print number exceeds the predetermined number was described. On the other hand, in this embodiment, the surface temperature of the fixing belt is detected and excess of the print number over the predetermined number is grasped and thereafter the soaking roller is contacted to the pressing roller.

In this embodiment, a constitution of a fixing device is the same as that in First Embodiment, and as shown in FIG. 2, a temperature sensor (thermistor or temperature detecting element) TH1 as a temperature detecting means is provided at a position of a central inner surface portion of the fixing belt 1 with respect to the widthwise direction in contact to the fixing belt 1. Incidentally, the temperature sensor TH1 detects the temperature of the fixing belt 1 at an inner peripheral surface of the fixing belt 1 but its detection information is converted into a surface temperature of the fixing belt 1 by using a table or the like stored in, e.g., a memory in the control circuit portion 102. Therefore, the surface temperature of the fixing belt 1 can be detected by the temperature sensor TH1. Incidentally, the temperature sensor is opposed or contacted to the outer peripheral surface of the fixing belt 1, so that the surface temperature of the fixing belt 1 may also be directly detected.

Thus, by detecting the fixing belt surface temperature with the temperature sensor TH1, the lowest temperature of the fixing belt during the sheet passing can be measured. The lowest temperature varies depending on an environment, the type of sheet (paper) and the like, and by preliminary study, a relationship between the lowest temperature and the environment and a relationship between the lowest temperature and the type of sheet are grasped, and its information is stored in the memory of the image forming apparatus. That is, in the case where a detection result of the temperature sensor TH1 is the lowest temperature stored in the memory, the soaking roller 9 is contacted to the pressing roller 2.

Incidentally, even when the lowest temperature is not obtained in advance, the lowest temperature can be grasped from the detection result of the temperature sensor TH1. This will be described. First, at the time when the temperature sensor TH1 detects the temperature, whether or not the detected toner is the lowest temperature is not discriminated. As described above, the fixing belt temperature is gradually lowered from job start and is, after the print number exceeds a certain number, gradually increased. Therefore, at the time when a state in which the fixing belt temperature is not lowered further can be grasped, it is possible to grasp that the fixing belt temperature exceeds the lowest temperature. That is, when the time of a change from the temperature decrease to the temperature increase is obtained, it is possible to grasp that the fixing belt temperature exceeds the lowest temperature.

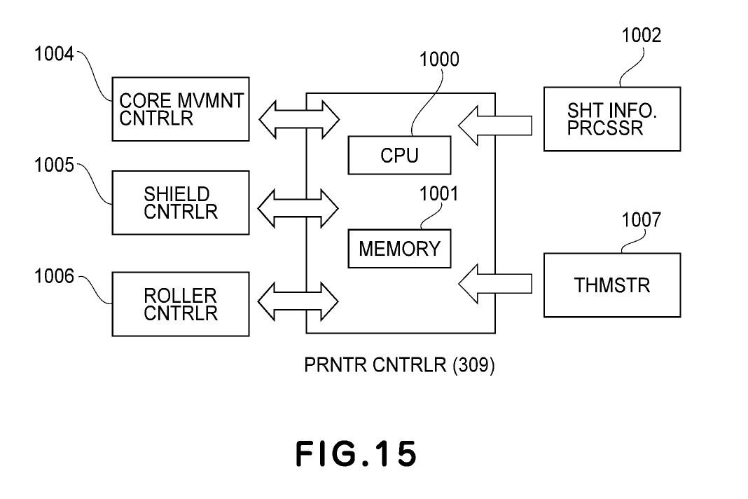

The control in this embodiment will be described with reference to a block diagram shown in FIG. 15. Information on the type of the recording material (on the sheet size and the sheet type) inputted from an operating portion 301 by or outputted from a PC (personal computer) by a user is sent to a recording material information processing portion 1002 and then the information of the recording material information processing portion 1002 is transferred to a CPU 1000. The CPU 1000 makes reference to a memory 1001 and discriminates, on the basis of the information of the recording material information processing portion 1002, an amount of movement control of the outside cores 7a and an amount of control of the magnetic flux shielding plate 11 and then transfers the respective control amounts to a core movement controller 1004 and a magnetic flux shielding plate controller 1005. Then, the core movement controller 1004 moves predetermined outside cores 7a away from the fixing belt 1, and the magnetic flux shielding plate controller 1005 moves the magnetic flux shielding plate 11 to a predetermined position.

Information of a thermistor 1007 is transferred to the CPU 1000. The information of the thermistor 1007 is a detection result of the temperature sensor TH1. The CPU 1000 discriminates, from its information, whether or not the fixing belt surface temperature exceeds the lowest temperature one time in the job. This discrimination may be effected by making reference to the lowest temperature checked and stored in the memory in advance as described above or may also be effected by grasping, on the basis of the change in temperature from the decrease to the increase, that the fixing belt temperature exceeds the lowest temperature. When the fixing belt temperature exceeds the lowest temperature, the CPU 1000 sends a command (instruction) to the soaking roller controller 1006, so that the soaking roller controller 1006 brings the soaking roller 9 into contact to the pressing roller 2.

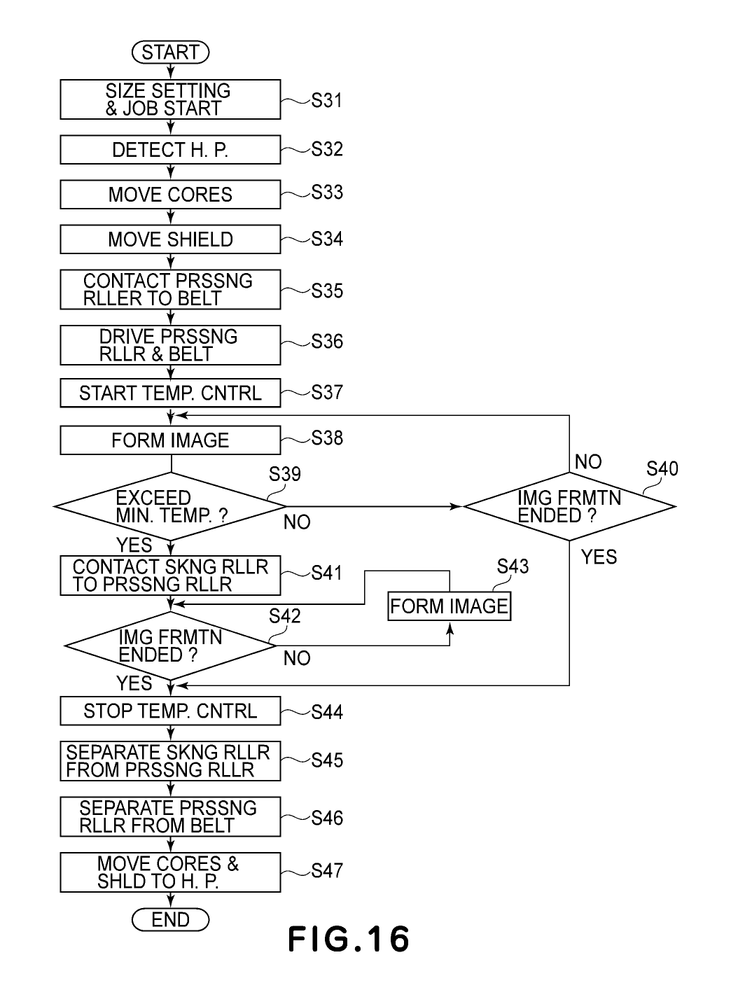

The control flow in this embodiment will be described with reference to a flow chart of FIG. 16. First, the type of the recording material is set through the operating panel or the PC and then a job for copy or print is sent to the image forming apparatus, so that the job is started (S31). Home position detection of the respective members (outside cores, magnetic flux shielding plate, soaking roller and pressing roller) is performed (S32).

Thereafter, depending on the paper (sheet) size, the outside cores and the magnetic flux shielding plate are moved (313 and S34). The pressing roller is contacted to and pressed against the fixing belt to form the nip N (S35). The pressing roller is rotationally driven to rotate the fixing belt (S36). A current is carried through the exciting coil to cause the fixing belt to generate heat and then the fixing belt is temperature-controlled (S37). At the image forming portions, the color toner images are formed and then transferred onto the recording material, followed by fixing and output of the image (S38).

Thereafter, the image formation is continued, and the CPU discriminates whether or not the fixing belt surface temperature exceeds the lowest temperature in one job (S39). When the fixing belt surface temperature does not exceeds, the lowest temperature even one time in one job (NO of S39) and the image formation is not ended (NO of S40), the sequence is returned to S38, and then the image forming operation is continuously repeated. When the fixing belt surface temperature exceeds the lowest temperature one time in one job (YES of S39), the soaking roller is contacted to the pressing roller to effect the control for suppressing the non-sheet-passing portion temperature rise (S41).

The CPU discriminates whether or not the image forming job is ended, and when the image forming job is not ended (NO of S42), the image forming operation is continuously repeated (S43). When the image forming job is ended (YES of S42), the current passing through the exciting coil is interrupted, so that the temperature control of the fixing belt is stopped (S44). When the soaking roller is contacted to the pressing roller, the soaking roller is separated from the pressing roller (S45). Then, the pressing roller is separated from the fixing belt (S46). Then, the outside cores and the magnetic flux shielding plate are moved to their initial positions (home positions) (S47) and thereafter the job is ended.

In this embodiment, after the fixing belt surface temperature detected by the temperature sensor TH1 exceeds the lowest temperature, the soaking roller is contacted to the pressing roller. In this case, the fixing belt surface temperature has already been changed from the decrease to the increased and therefore even when the soaking roller is contacted to the pressing roller, the fixing belt surface temperature is not decreased again and thus excessive lowering in temperature of the fixing belt can be prevented. Further, it is possible to suppress that the toner is detached from the recording material.

In the above description, after the temperature sensor TH1 detects the lowest temperature, the soaking roller is contacted to the pressing roller. However, the timing when the soaking roller is contacted to the pressing roller may also be timing when the number of sheets of the recording material passing through the nip after the temperature sensor TH1 detects the lowest temperature reaches a predetermined number. That is, the above-described effect can be obtained when the soaking roller is contacted to the pressing roller after the fixing belt surface temperature exceeds the lowest temperature, and therefore, the soaking roller is not necessarily required to be contacted to the pressing roller immediately after the detection of the lowest temperature. However, in order to effectively suppress the non-sheet-passing temperature rise, the above-described predetermined number may preferably be 50 sheets.

### [Verification Result]

A result of verification of the constitution in this embodiment will be described.

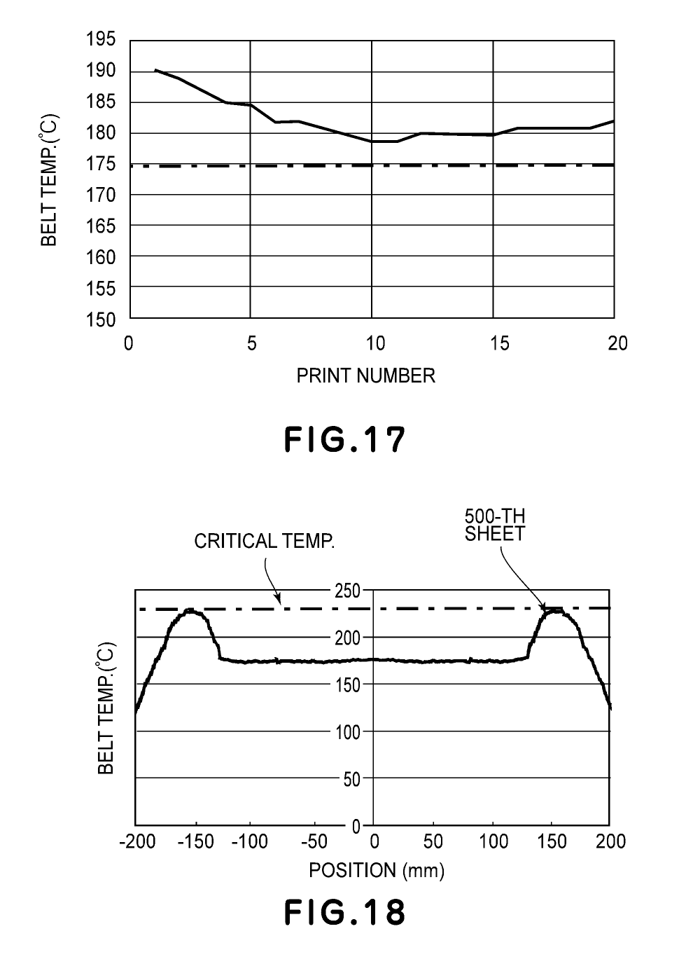

In the fixing device having the above-described constitution, sheets of an A4-sized recording material (“CF-C104”, available from Canon K.K.) were continuously passed through the nip in an environment of a temperature of 15° C. and a relative humidity of 15% RH. First, a progression of the belt surface temperature with respect to a print number of sheets (sheet passing number) is shown in FIG. 17. The belt surface temperature was measured at a belt central portion by using an infrared radiation thermometer “IT2-50”, mfd. by KEYENCE CORPORATION). As shown in FIG. 17, in this embodiment, the belt surface temperature is not lowered to 175° C. which is the temperature where the toner is detached (separated) from the recording material.

Next, a longitudinal temperature distribution with respect to the print number when 500 sheets of the recording material are passed through the nip in the fixing device 500 at a rate of 80 ppm is shown in FIG. 18. The longitudinal temperature distribution of the fixing belt 1 was measured by using infrared thermography “FSV-7000S”, mfd. by Apiste Corporation).

As shown in FIG. 18, even after the 500 sheets subjected to the continuous sheet passing, the temperature at the non-sheet-passing portion was less than 230° C. as a critical temperature, so that the non-sheet-passing portion temperature rise could be suppressed. Incidentally, when the fixing belt temperature is higher than the critical temperature, the belt is deteriorated so that a durable sheet passing number is remarkably decreased.

As described above, when the fixing device in this embodiment is used, even when various types of widthwise sizes of the recording materials are used, it is possible to sufficiently avoid the non-sheet-passing portion temperature rise without causing an increase in size of the fixing device.

In this embodiment, the constitution in which the soaking roller is contacted to the pressing roller after the fixing belt temperature exceeds the lowest temperature is described but as another embodiment, a constitution in which the fixing belt temperature at the non-sheet-passing portion is detected and on the basis of information on the detected temperature, the soaking roller is contacted to the pressing roller may also be employed.

### Other Embodiments

In the above-described embodiments, the case where the image heating apparatus is the fixing device for fixing unfixed toner images, formed (transferred) on the recording material, on the recording material was described as an example. However, the present invention is also applicable to the case where the image heating apparatus is a gloss-imparting apparatus for improving glossiness of an image by heating the image fixed on the recording material. Also in the case of such a gloss-imparting apparatus, there can arise the problem of the overheating at the non-sheet-passing portion similarly as in the case of the fixing device, and therefore the overheating can be suppressed by the contact of the soaking roller.

Further, when the soaking roller is contacted to the pressing roller from the job start, the lowest temperature is excessively lowered and thus, e.g., there is a possibility that the gloss cannot be imparted. Therefore, similarly as in the above-described embodiments, the timing when the soaking roller is contacted to the pressing roller is delayed on the basis of the discrimination of the print number and the detected fixing belt surface temperature, so that it is possible to prevent excessive lowering in lowest temperature.

### INDUSTRIAL APPLICABILITY

According to the present invention, it is possible to provide an image heating apparatus capable suppressing excessive temperature rise of an endless belt without causing upsizing of the image heating apparatus.

While the invention has been described with reference to the structures disclosed herein, it is not confined to the details set forth and this application is intended to cover such modifications or changes as may come within the purpose of the improvements or the scope of the following claims.

1. An image heating apparatus comprising:
an endless belt for heating a toner image on a recording material in a nip;
an exciting coil for heating said endless belt by electromagnetic induction heating;
a rotatable driving member for forming the nip between itself and said endless belt and for rotationally driving said endless belt;
a magnetic flux suppressing member for suppressing magnetic flux when a predetermined recording material having a width narrower than a maximum-width recording material usable in said image heating apparatus is subjected to image heating, wherein the magnetic flux, of magnetic flux directed from said exciting coil toward said endless belt, is directed toward a part of a region outside, with respect to a widthwise direction of said endless belt, of a region where said endless belt is contactable to the predetermined recording material; and
a rotatable heat-absorbing member for absorbing heat from said rotatable driving member in contact therewith.

2. An apparatus according to claim 1, further comprising a contact-and-separation mechanism for moving said rotatable heat-absorbing member toward and away from said rotatable driving member.

3. An apparatus according to claim 2, further comprising a controller for controlling an operation of said contact-and-separation mechanism,
wherein said controller brings said rotatable heat-absorbing member into contact to said rotatable driving member when sheets of the predetermined recording material in a predetermined number are continuously subjected to the image heating.

4. An apparatus according to claim 2, further comprising a temperature sensor for detecting a temperature of said endless belt at a widthwise end portion and a controller for controlling an operation of said contact-and-separation mechanism on the basis of an output of said temperature sensor,
wherein said controller brings said rotatable heat-absorbing member into contact to said rotatable driving member when a detection temperature by said temperature sensor is lowered to a predetermined temperature.

5. An apparatus according to claim 1, further comprising a moving mechanism for moving said magnetic flux suppressing member substantially along a widthwise direction of said endless belt depending on a widthwise length of the recording material.

6. An apparatus according to claim 1, wherein said exciting coil is provided in the neighborhood of the outside of said endless belt.

7. An apparatus according to claim 6, further comprising a plurality of magnetic cores provided in a side remote from said endless belt more than said endless belt and is arranged in the widthwise direction of said endless belt.

8. An apparatus according to claim 7, further comprising a retracting mechanism for retracting, depending on a widthwise length of the recording material, at least one magnetic core of the plurality of magnetic cores from said exciting coil.

9. An apparatus according to claim 1, wherein said image heating apparatus fixes an unfixed toner image, formed on the recording material, in the nip.

10. An apparatus according to claim 1, wherein said rotatable heat-absorbing roller is capable of being rotated by rotation of said rotatable driving member.

11. An image heating apparatus comprising:
an endless belt for heating a toner image on a recording material in a nip;
a plurality of magnetic cores arranged in a widthwise direction of said endless belt;
an exciting coil for heating said endless belt by electromagnetic induction heating;
a rotatable driving member for forming the nip between itself and said endless belt and for rotationally driving said endless belt;
a retracting mechanism for retracting, depending on a widthwise length of the recording material, at least one magnetic core of the plurality of magnetic cores from said exciting coil; and
a rotatable heat-absorbing member for absorbing heat from said rotatable driving member in contact to said rotatable driving member.

12. An apparatus according to claim 11, further comprising a contact-and-separation mechanism for moving said rotatable heat-absorbing member toward and away from said rotatable driving member.

13. An apparatus according to claim 12, further comprising a controller for controlling an operation of said contact-and-separation mechanism,
wherein said controller brings said rotatable heat-absorbing member into contact to said rotatable driving member when sheets of the predetermined recording material in a predetermined number are continuously subjected to the image heating.

14. An apparatus according to claim 12, further comprising a temperature sensor for detecting a temperature of said endless belt at a widthwise end portion and a controller for controlling an operation of said contact-and-separation mechanism on the basis of an output of said temperature sensor,
wherein said controller brings said rotatable heat-absorbing member into contact to said rotatable driving member when a detection temperature by said temperature sensor is lowered to a predetermined temperature.

15. An apparatus according to claim 11, wherein said exciting coil is provided in the neighborhood of the outside of said endless belt, and
wherein said a plurality of magnetic cores are provided in a side remote from said endless belt more than said endless belt.

16. An apparatus according to claim 11, wherein said image heating apparatus fixes an unfixed toner image, formed on the recording material, in the nip.

17. An apparatus according to claim 11, wherein said rotatable heat-absorbing roller is capable of being rotated by rotation of said rotatable driving member.
